(19) United States
(12) Patent Application Publication
(10) Pub. No.: US 2024/0335727 A1
(43) Pub. Date: Oct. 10, 2024

(54) Sports Training Goggle

(71) Applicant: Edward Allen Sprigler, Georgetown, IN (US)

(72) Inventors: Edward Allen Sprigler, Georgetown, IN (US); Mark Hallam, Jeffersontown, KY (US); Michael Goldenbogen, Louisville, KY (US); Steve J. Cannon, Louisville, KY (US); Steven L. Cannon, Louisville, KY (US); Vas Abramov, Louisville, KY (US); Michael White, Louisville, KY (US)

(21) Appl. No.: 18/295,615

(22) Filed: Apr. 4, 2023

(51) Int. Cl. A63B 71/06; G02C 5/00

(52) U.S. Cl. CPC A63B 71/0622; G02C 5/001; A63B 2102/18; A63B 2102/32; A63B 2243/007

(57) ABSTRACT

A pair of sports training goggles includes a faceplate having a pair of opposed temples shaped to engage the head of a user and a pair of viewing apertures disposed in general alignment with the eyes of the user. A pair of spaced ocular sockets disposed generally over the eyes of the user each has a central aperture and first and second lenses, each shaped to engage the ocular sockets and occlude the central apertures.

### BACKGROUND OF THE INVENTION

### Field of the Invention

The present invention relates generally to a system and apparatus for training the vision and eye focus of an individual involved in an athletic endeavor utilizing an improved sport training goggle that forces the eyes to focus on a narrow field.

### Description of the Related Art

In many sports the ability of an athlete to focus on a ball, whether moving or stationary, is determinative of success in making consistent contact with the ball, whether that be with a bat, glove, hand, foot, or other body part. In golf, for example, athletes attempt to hold their heads relatively still throughout the backswing and downswing until the moment the club impacts the ball, so that their eyes may focus exclusively on the point at which they want the golf club to contact the ball. Similarly, baseball players try to keep their head relatively still and level while swinging through the ball to enable their eyes to focus tightly on the ball, thereby enhancing the chance of making the minute adjustments required to make consistent solid contact. Coaches often implore baseball players to “keep their head on the ball” while their bodies rotate through the swing to avoid misses.

In order to aid in the focus of the athletes in a wide variety of athletic endeavors, some prior art devices such as goggles or glasses exist that attempt to narrow or limit an athletes field of vision so that the head must remain more stationary to focus on the target. However, known prior art systems lack adjustability and simply don't work well. Some deploy “blinders” that limit an athlete's peripheral vision while others use strobe technology to focus the eyes, but these devices are typically unwieldy and of dubious effectiveness. Furthermore, these devices are often sport-specific, requiring a user or athlete to purchase multiple devices to train for more than one sport.

Based on the foregoing, there is a need in the art for a goggle system and apparatus for an athlete that provides a training aid that focuses the eyes on a target that is easy to wear, adjust, and customize.

### SUMMARY OF THE INVENTION

The goggle embodiments described in this specification overcome the aforementioned difficulties and deficiencies in the prior art by providing an improved sports training goggle that includes a flexible faceplate that conforms generally to an athlete or user's face and temples, so that the goggles can be worn just as other sports goggles are. In some aspects and embodiments the temples can be form fitting or snug to aid in goggle retention, and in others an adjustable strap may be fitted to each opposed temple. The strap can then be tightened around the users' head to secure the goggle in place. The faceplate also may include a bridge that rests on the user's nose. In some aspects the faceplate can be comprised of a polycarbonate or ABS material.

In one embodiment and aspect of the instant invention, the faceplate includes a pair of spaced ocular sockets, on either side of the bridge shaped to generally accommodate the eyes while allowing space between the eye and the socket. The sockets are spaced so that each eyes of an average person are more or less centered in each socket. In some embodiments each socket accommodates a lens having an aperture therein through which light may pass and through which the user may look. The lenses may be shaped as a truncated hemisphere, a circle, or an oval in some embodiments, and include a tab or grip that permits a user to swivel or rotate the lens through a range of motion, thereby moving the aperture through which the user can see to a location that suits the user's desired position.

Furthermore, in some aspects and embodiments the ocular sockets are secured to the faceplate by a hinge located at an upper edge of the faceplate and an upper edge of the ocular sockets. In other embodiments each ocular socket is secured to the faceplate only by a hinge while in some embodiments a bridge is disposed between the ocular sockets to lend them stability as they rotate together. These features of the invention permit the ocular sockets to be “flipped” open, thereby allowing a user an unrestricted field of vision. This is particularly advantageous when the athlete needs to take a break or interrupt training without the necessity of removing the goggles entirely.

In some exemplary but non-limiting embodiments a variety of lenses having different aperture diameters may supplied with a pair of goggles so that a user can quickly and easily change out the lenses required for a specific training application. Smaller lens apertures can be used to encourage an athlete to keep their head still during an athletic movement such as a golf or baseball swing, while larger apertures can be used for catching exercises where an athlete needs to visually track a ball while simultaneously moving to its terminal location.

In some aspects and embodiments the ocular sockets are configured to accept a relatively flat lens that is secured in place in the socket by a retaining ring, or retainer, that still enables the user to move the lens aperture around in the socket. In some embodiments flat lenses and retainers may be secured with fasteners or with a quarter turn lock system, thereby allowing rapid changing of lenses for applications requiring different aperture sizes.

Other features, objects and advantages of the embodiments described herein will become apparent from the detailed description of the invention taken in conjunction with the appended drawing Figures.

### BRIEF DESCRIPTION OF THE DRAWING FIGURES

FIG. 1 is a perspective view of a training goggle in accordance with some aspects and embodiments;

FIG. 2 is a perspective view of a training goggle in accordance with some aspects and embodiments;

FIG. 3 is a top view of a training goggle in accordance with some aspects and embodiments;

FIG. 4 is a perspective view of a training goggle in accordance with some aspects and embodiments;

FIG. 5 is a cross-sectional view of a training goggle taken along the line 5-5 of FIG. 4 in accordance with some aspects and embodiments;

FIG. 6 is a side view of a training goggle in accordance with some aspects and embodiments;

FIG. 7 is a perspective view of a lens in accordance with some aspects and embodiments;

FIG. 8 is a side view of a lens in accordance with some aspects and embodiments;

FIG. 9 is a top view of a lens goggle in accordance with some aspects and embodiments;

FIG. 10 is a cross-sectional view of a lens taken along the line 10-10 of FIG. 9 in accordance with some aspects and embodiments;

FIG. 11 is a top view of a training goggle in accordance some aspects and embodiments;

FIG. 12 is a perspective view of a training goggle in accordance with some aspects and embodiments;

FIG. 13 is a perspective view of a training goggle in accordance with some aspects and embodiments;

FIG. 14 is a perspective view of a lens in accordance with some aspects and embodiments;

FIG. 15 is a perspective view of a training goggle in accordance with some aspects and embodiments;

FIG. 16 is a partial side view of a training goggle worn by a user in accordance with some aspects and embodiments;

FIG. 18 is a perspective view of a training goggle in accordance with some aspects and embodiments;

FIG. 19 is a perspective view of an ocular socket in accordance with some aspects and embodiments;

FIG. 20 is a cross-sectional view of a socket and lens in accordance with some aspects and embodiments;

FIG. 21 is a cross-sectional view of a training goggle in accordance with some aspects and embodiments;

FIG. 22 is a perspective view of a training goggle in accordance with some aspects and embodiments;

FIG. 23 is a perspective view of a training goggle in accordance with some aspects and embodiments;

FIG. 24 is a top view of a training goggle in accordance with some aspects and embodiments;

FIG. 25 is a an exploded perspective view of a training goggle in accordance with some aspects and embodiments;

FIG. 26 is an prespective view of a training goggle in accordance with some aspects and embodiments;

FIG. 27 is an exploded perspective view of a training goggle in accordance with some aspects and embodiments;

FIG. 28 is a perspective view of a training goggle in accordance with some aspects and embodiments; and

FIG. 29 is an exploded perspective view of a training goggle in accordance with some aspects and embodiments.

### DETAILED DESCRIPTION OF THE PREFERRED EMBODIMENT(S)

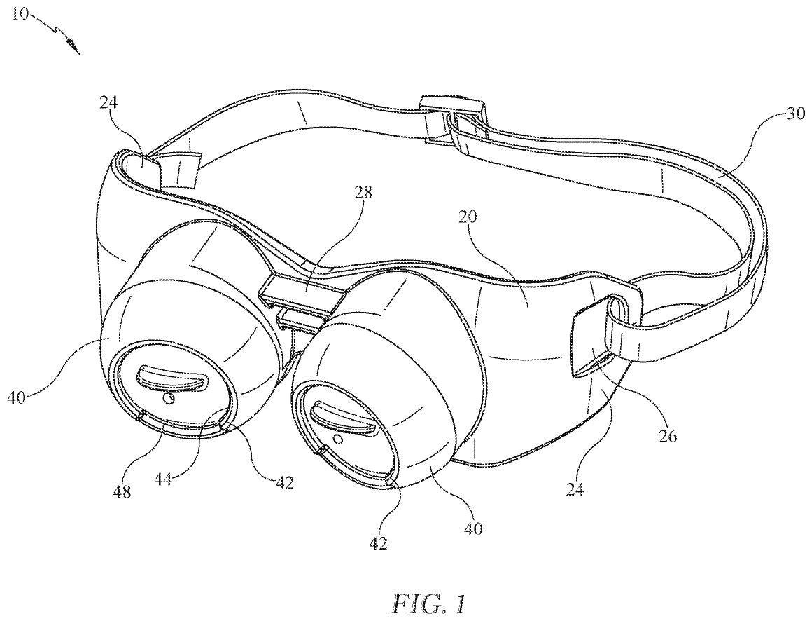

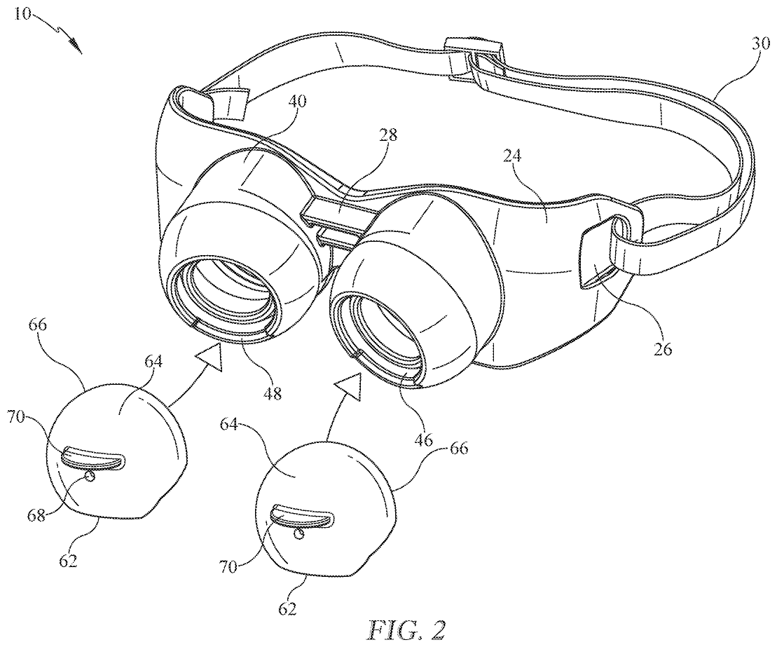

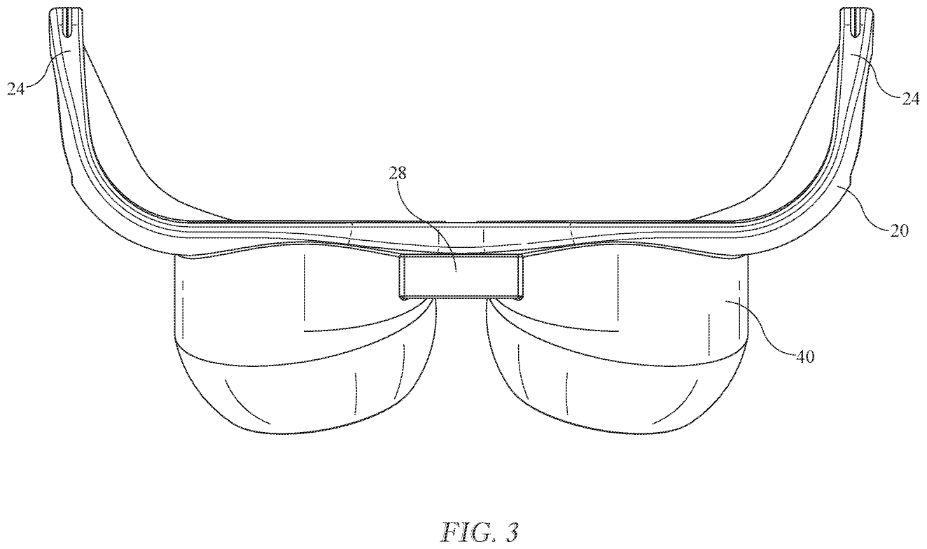

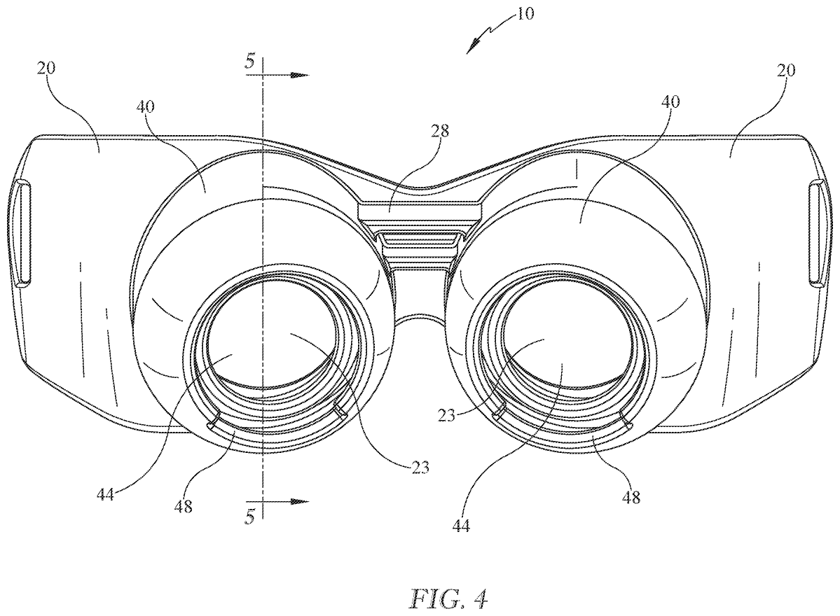

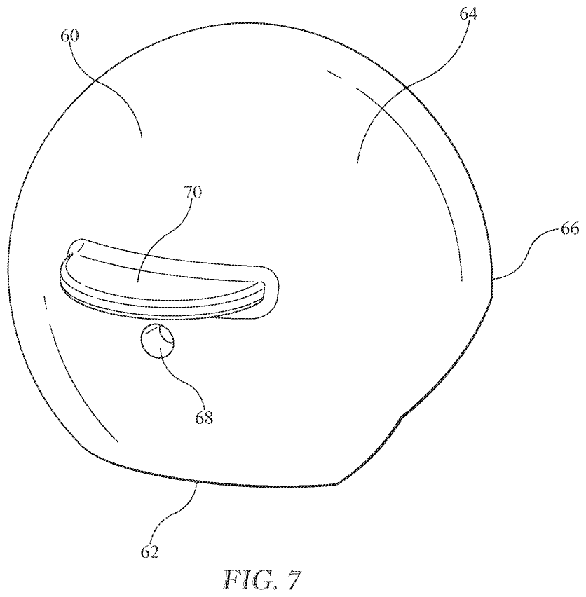

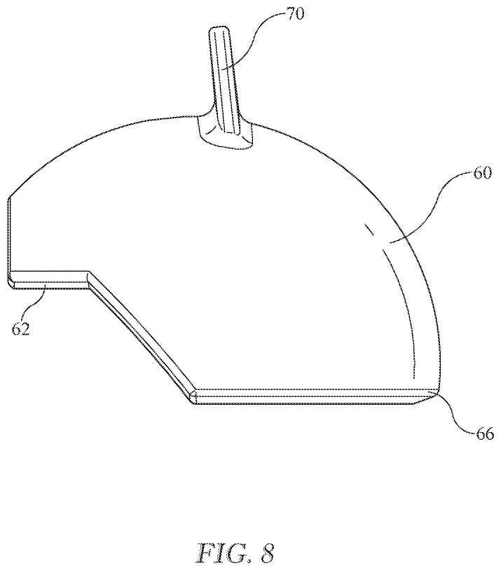

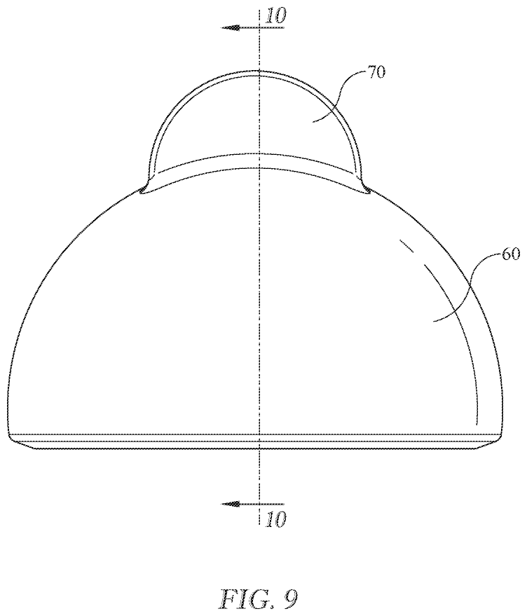

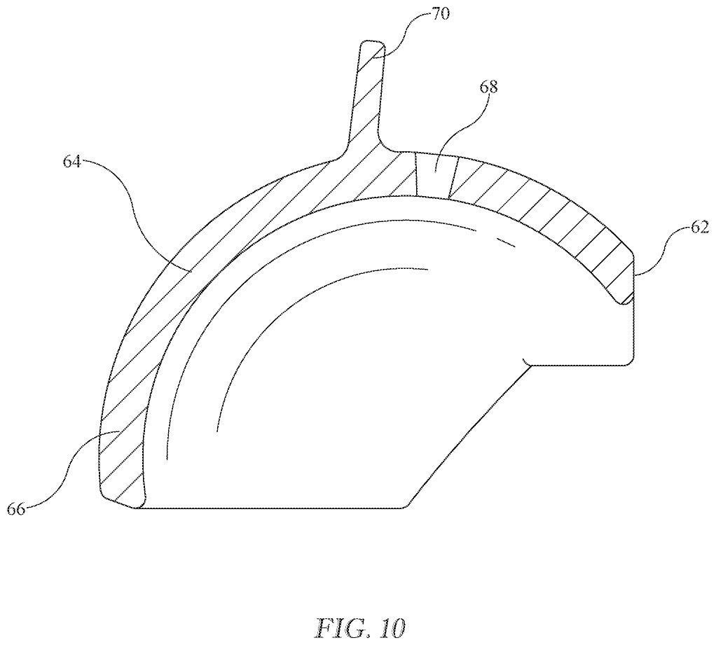

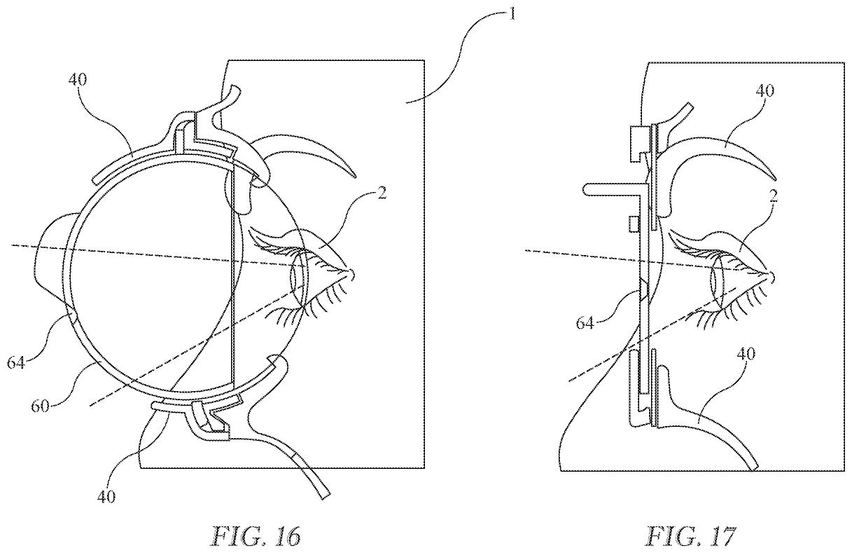

Referring now to FIGS. 1-10 and in accordance with some embodiments and aspects of the present invention a sports training goggle 10 for training a user 1 or athlete to focus on a target or other object may include a faceplate 20, generally shaped to conform to the face of a user 1 as depicted in profile in FIGS. 16 and 17. Faceplate 20 may have include a pair of eye apertures for user 1 to see through disposed generally between a pair of opposed temples 24 that may in some embodiments have a curvature that generally conforms to the temple area of user 1. Each temple 24 may further include a temple aperture 26 that accepts a head strap 30 for securing goggle 10 to the user. As best seen in FIGS. 1 and 2, faceplate 20 may extend substantially between temples 24 across and over user's 1 face and nose. It should be noted that for purposes of this specification the terms user 1 and athlete may be used synonymously.

In some exemplary aspects faceplate 20 has a pair of ocular sockets 40, one for enclosing a user's 1 left eye 2 and one enclosing the right eye 2, that extend outwardly away from a user's face, as seen in FIG. 16 for example. Faceplate 20 may also include a bridge 28 positioned between ocular sockets 40 to provide stiffness and stability to goggles 10. Ocular sockets 40 may in some embodiments be generally hemispherical in shape, terminating in a truncated edge 42 that defines a lens opening 44. As best depicted in FIGS. 2-5 ocular sockets 40 may also include an inner annular void 46 that is bounded on an exterior portion of ocular socket 40 by a hemispherical flange 47 that is shaped to accept and be engaged by an adjustable lens 60. Additionally, ocular sockets 40 may include a notch 48 in a lower portion thereof that is provided to engage a shaped bottom edge 62 of lens 60.

As best seen in FIGS. 1 and 7-10 lens 60, in some aspects and embodiments, may have a generally truncated or partial hemispherical shape and be sized to generally engage annular void 46 of ocular socket 40 so that lens 60 may be rotated and positioned within ocular socket 40. Bottom edge 62 of lens 60 generally engages notch 48 of ocular socket 40 when lens 60 is rotated downwardly to a terminal position. Lens 60 may further include an upper portion 64 that terminates in a trailing edge 66 that engages annular void 46, thereby enabling a user 1 to move lens 60 upwardly, downwardly, and side to side.

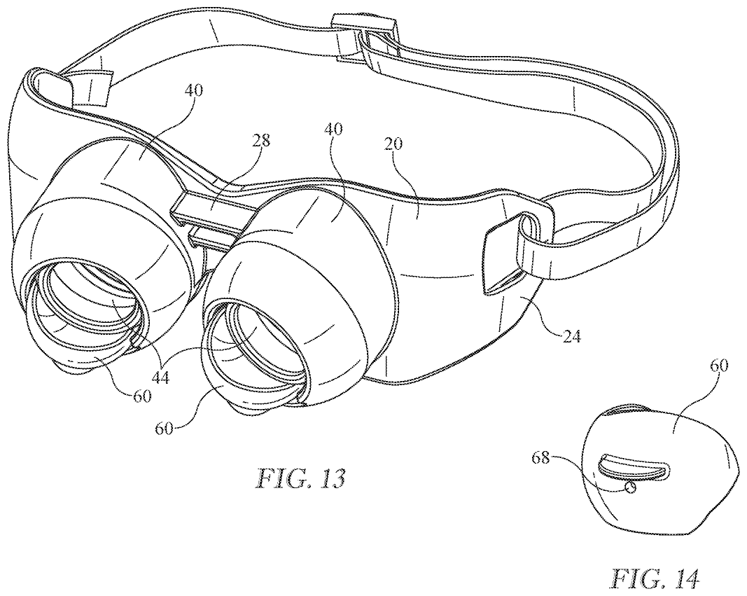

Additionally, an aperture 68 is provided generally disposed proximate the center of lens 60 through which a user 1 may see, as best depicted in FIGS. 16 and 17. In some aspects, a tab or visor 70 protrudes from lens 60 and is positioned above aperture 68. Tab 70 may be grasped by user 1 to rotate and position lens 60 such that user 1 may accurately focus their vision through aperture 68 (of either eye or both). Tab 70 further shields aperture 68 from overhead sunlight thereby enabling user 1 to more readily focus their vision on an object or target. Additionally, and as best seen in FIG. 13, in some embodiments tab 70 may be grasped and used to rotate lens 60 downwardly, so that bottom edge 62 engages socket 40 annulus 46 whereby trailing edge 66 of lens 60 disengages ocular socket 40 thereby providing a direct line of sight out of lens opening 44, rather than requiring a user to see only through apertures 68. This embodiment of the invention permits user 1 to open lenses 60 to widen the field of vision when training goggle 10 is not in use without the necessity of removing goggle 10 from the face.

In further aspects and embodiments sports goggle 10 and its various components may be formed of an impact-resistant plastic or other polymer suitable for contact with human skin that is also readily molded or formed into the shapes required by the components of the sports goggle 10 described herein. In some non-limiting embodiments ABS plastic or polycarbonate plastic may be employed in constructing the various components of goggle 10 A goggle 10 formed of impact-resistant components is advantageous in some embodiments since the user 1 may be protected from an inadvertent strike by a ball, for example a baseball, when training with goggle 10.

In various embodiments and aspects faceplate 20 and concomitant ocular sockets 40 may be molded or manufactured in a single-piece construction for ease of manufacturability and reduced cost. Additionally, lenses 60 may also be comprised of an impact-resistant polymer such as ABS or polycarbonate such that lenses 60 are removable and replaceable from ocular socket 40. In certain embodiments lenses 60 may be simply inserted or “snapped” into ocular sockets 40 such that lens 60 trailing edges 66 engage ocular socket 40 annulus 46, thereby permitting lenses 60 to be movable within ocular sockets 40.

In some embodiments a variety of lenses 60 having different aperture 69 diameters may be provided so that a user 1 may change lenses 60 as required for a specific application. For example, when training an athlete in a golf drill or a baseball batting drill, a smaller lens 60 aperture 68 may be employed to encourage user 1 to keep their head stationary throughout the swing. In a baseball or football catching exercise, lens 60 aperture 68 may be slightly larger to permit a user 1 to have a wider field of vision since the acts of catching may require a wider vision field to accurately track a ball in those sports. In some exemplary but non-limiting embodiments aperture 68 diameter may be in a range between 1.75 and 7.0 mm depending upon the user's 1 sport and individual preference. Aperture 68 diameters larger than 7.0 mm may be employed in some applications where user 1 is just beginning to adjust to sports training goggle 10. Since in certain embodiments a plurality of removable and replaceable lenses 60 may be supplied with sports training goggle 10 a user 1 or coach has the ability to change lenses 60 and thus reduce aperture sizes 68 as the user's 1 training advances and they become more adept at focusing on a target during a given athletic endeavor.

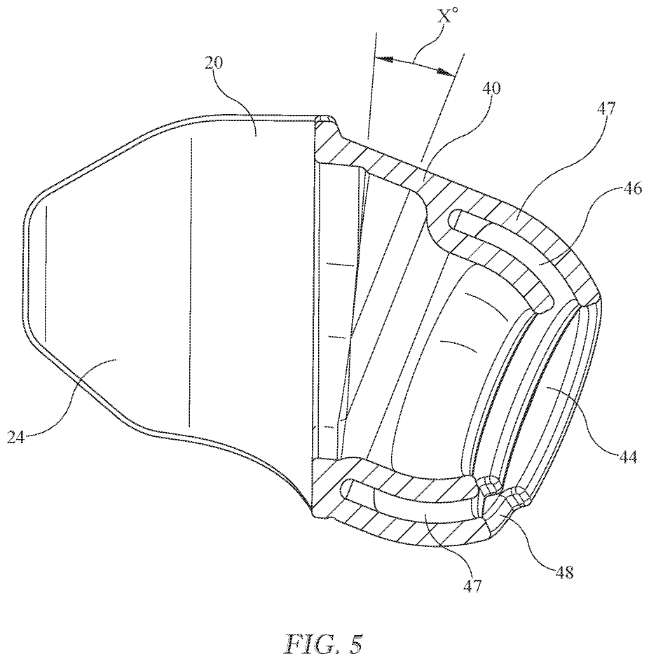

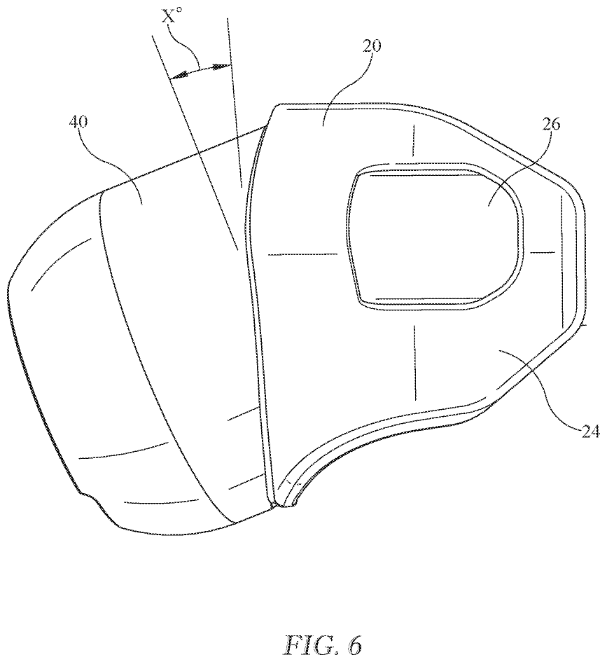

Referring now to FIGS. 5 and 6, and in accordance with various aspects and embodiments ocular sockets 40 may have a downward angle X between faceplate 20 and ocular socket 40 opening 44 that requires user 1 to train their vision slightly downwardly through aperture 68. In these embodiments the angle of orientation of ocular socket 40 in combination with the location and orientation of lens 60 aperture 68 encourages user 1 to keep their head up throughout their training, while focusing intently through lens 60 aperture 68, thereby disciplining the user's focusing ability.

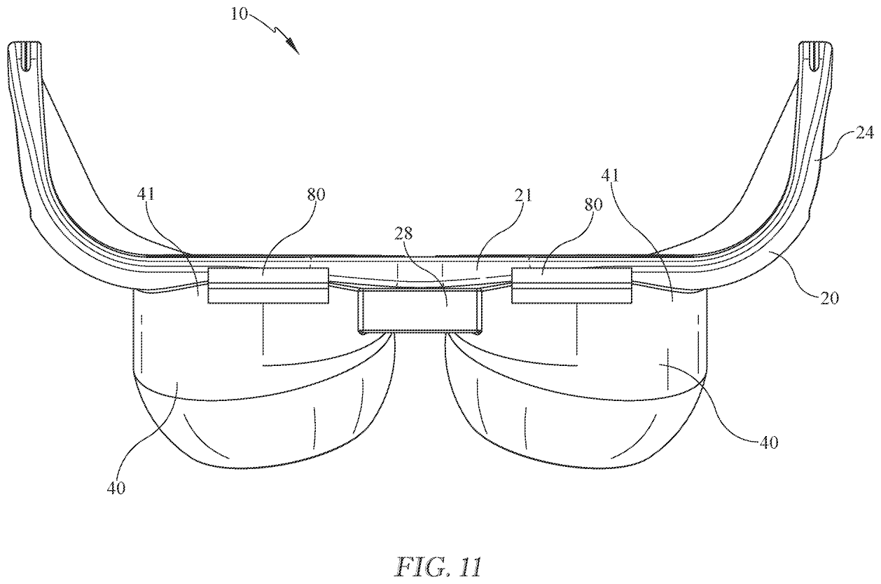

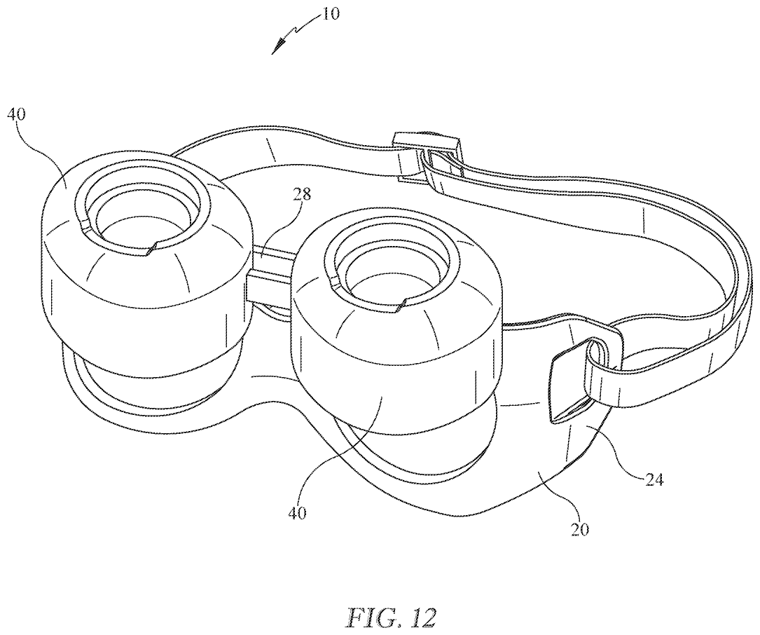

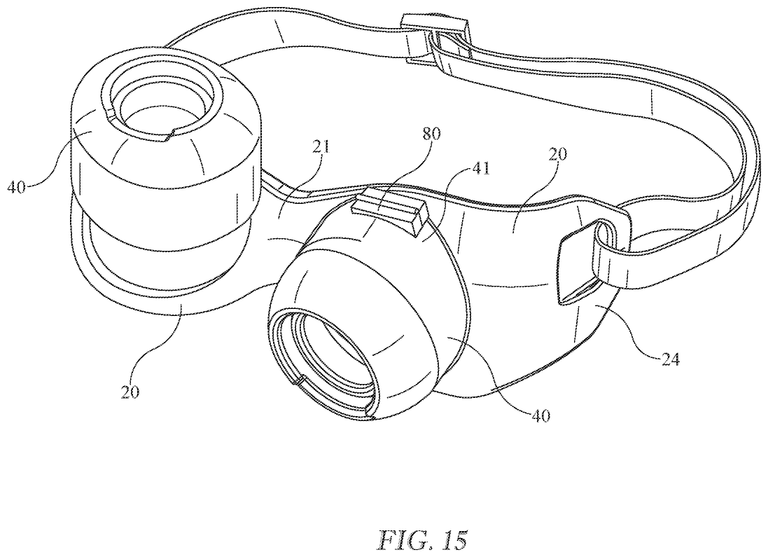

Referring now to FIGS. 11, 12 and 15, and in accordance with further aspects and embodiments ocular sockets 40 are each secured to faceplate 20 by operation of a hinge 80 connecting an upper edge 21 of faceplate 20 and an upper edge 41 of ocular sockets 40. In some embodiments bridge 28 may be disposed between and secured to ocular sockets 28 to provide stability to both ocular sockets 40 when they are rotated upwardly into their “open” position, away from faceplate 20. In other embodiments each ocular socket 40 is secured to faceplate 20 upper edge 21 only by hinge 80. Additionally, ocular sockets 40 in some embodiments fit securely against faceplate 20 when rotated to their “closed” or downward position. This feature eliminates light leakage between ocular sockets 40 and faceplate 20 that may distract user 1 while sports training goggle 10 is being used for training. When a user 1 wishes to have a wider field of vision, for example during a break from a training exercise, ocular sockets 40 may be rotated to their open position as depicted in FIG. 12 by operation of hinges 80, thereby allowing user 1 a to see without the necessity of removing goggles 10.

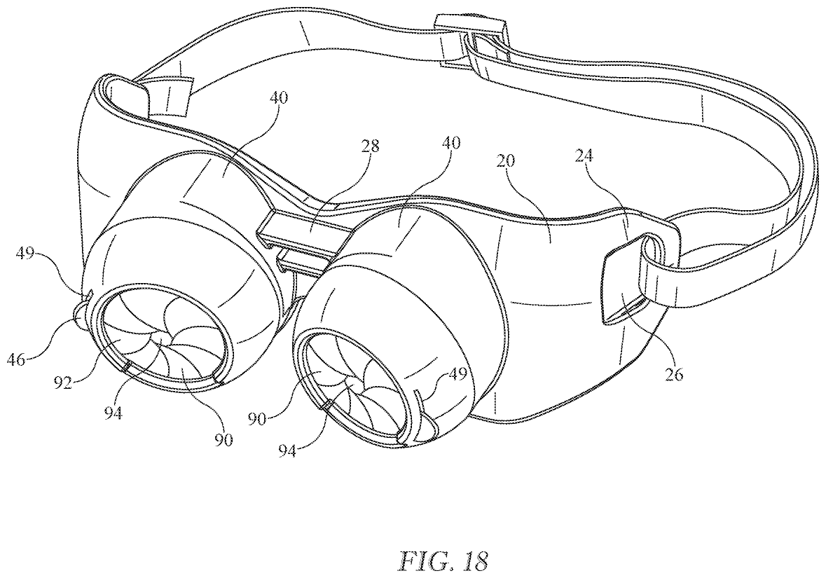

In yet further aspects and embodiments and as depicted in FIG. 18, ocular sockets 40 may be fitted with a variable aperture 90 to restrict lens opening 44. Variable aperture 90 may comprise a plurality of variable position vanes 92 that rotate inwardly or outwardly to form an aperture 94 responsive to an adjustment tab 96. In these embodiments ocular sockets 40 may include a slot 49 through which adjustment tab 96 protrudes so that user 1 may quickly adjust aperture 94 of each variable aperture 90. This embodiment of the invention also permits user 1 to quickly and easily open aperture 94 wide when goggle 10 is not being used for training, while providing nearly infinite adjustment for aperture 94 for training purposes.

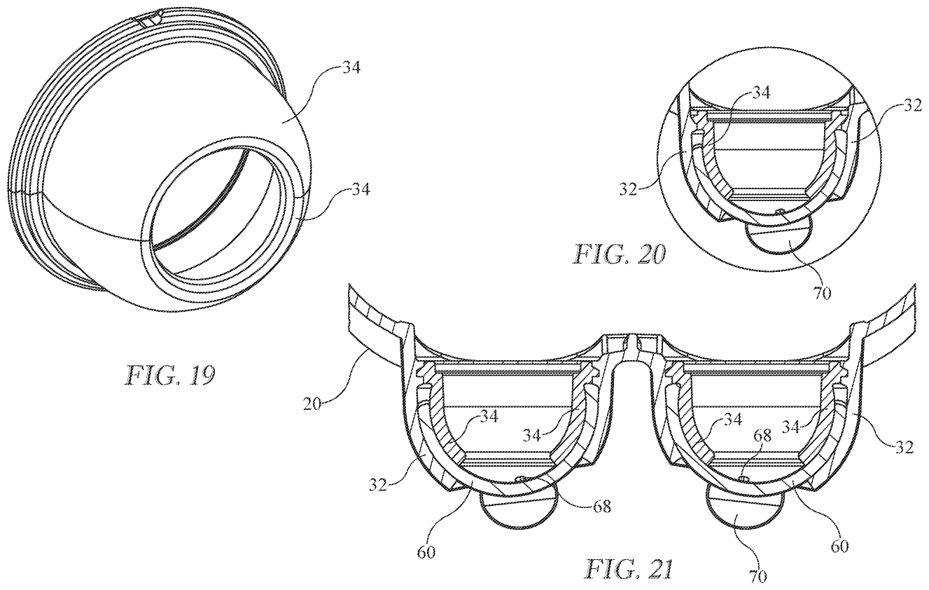

Referring now to FIGS. 19-21, and in accordance with some embodiments, faceplate 20 may include a hemispherical flange 32 extending forwardly to form an outer portion of ocular socket 40. A removable interior socket 34 is provided that engages faceplate 20 so that interior socket 34 and lens 60 may be removed and replaced as a two-piece unit. Hemispherical flange 32 and interior socket 34, when installed, form annular void 46 into which lens 60 may be inserted to complete the sports training goggle 10 assembly. In some embodiments removable interior socket 34 may be formed with a two-piece construction as depicted in FIG. 19, so that it may be more easily be installed and removed by user 1. Interior socket 34 may include a flanged edge 35 that may engage a mating edge 37 disposed on hemispherical flange 32 to allow interior socket 34 to “snap” into place securely. Furthermore, interior socket 34 may also be formed of a flexible polymer such as ABS or polycarbonate to aid in installation and removal.

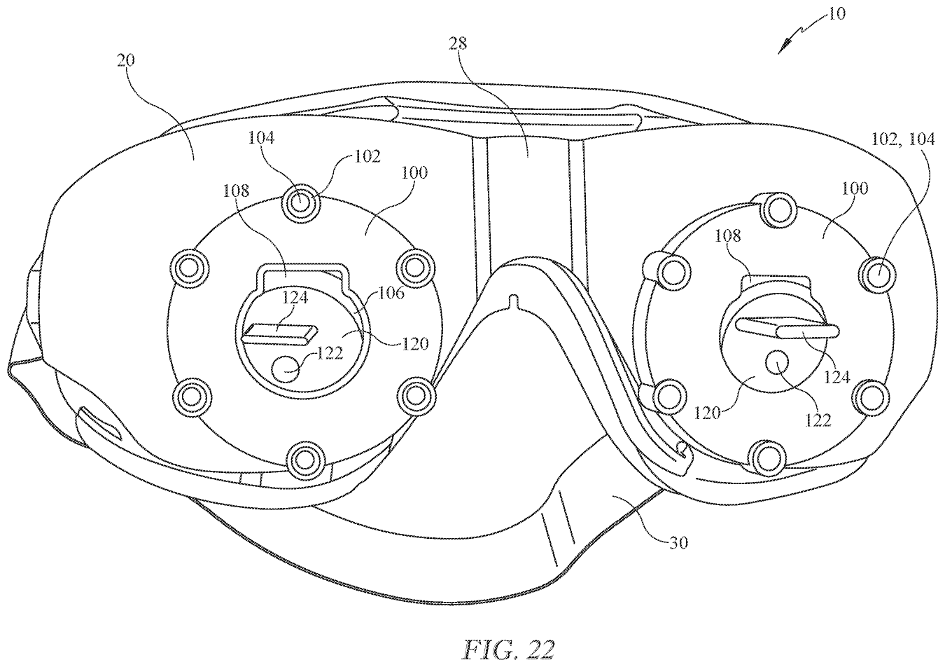

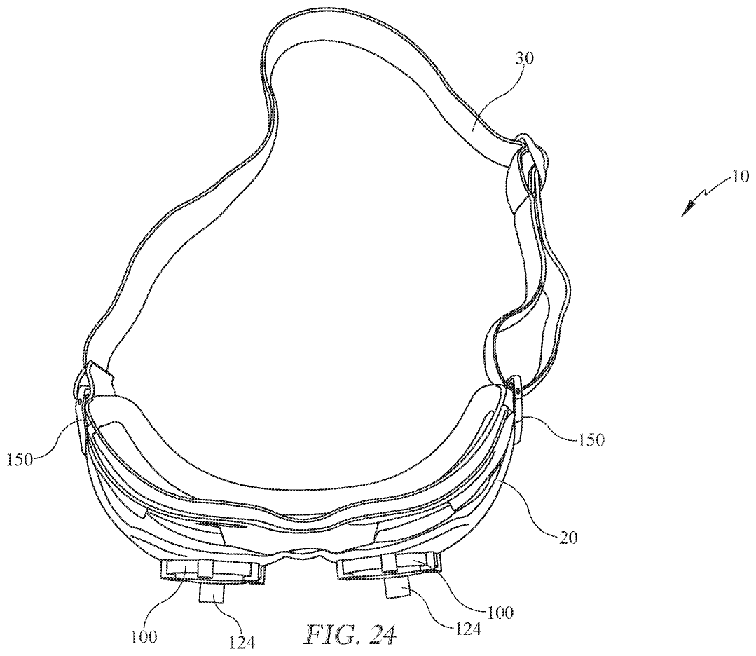

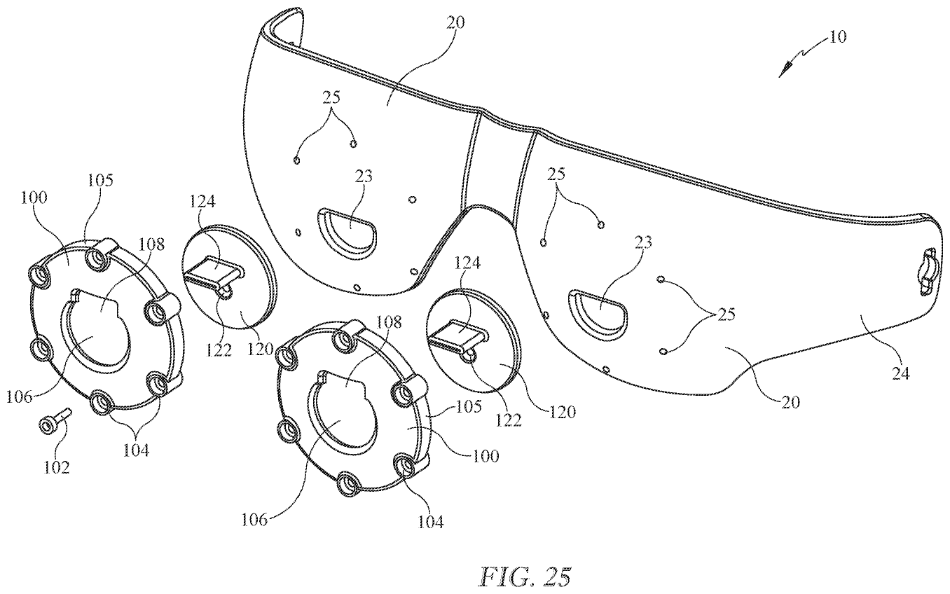

Referring now to FIGS. 22-26 and in accordance with further embodiments training goggle 10 may utilize a lens retainer 100 to capture and secure a lens 120 to faceplate 20. In this embodiment lens retainer 100 may include a plurality of fasteners 102 that engage a plurality of fastener apertures 104 spaced around an edge 105 of retainer 100. In some aspects fasteners are inserted through apertures 104 and engage corresponding faceplate fastener apertures 25 to secure retainer 100 to faceplate 20. Retainer 100 further includes a central lens access aperture 106, having a tab slot 108 on an upper edge thereof.

As depicted, in these embodiments lens 120 comprises a relatively flat, generally circular lens 120 having an aperture 122 therein. It should be noted that lens 120 can be any shape, as long as it is sized to be accepted in ocular socket 40. Additionally lens 120 is captured or secured between retainer 100 and faceplate 20 such that a lens aperture 122 may be aligned with a faceplate viewing aperture 23, thereby permitting user 1 to see through lens aperture 122. A pair of spaced faceplate viewing apertures 23 are disposed generally so that an average user 1 may see through viewing apertures 23 with each eye. In some exemplary but non-limiting embodiments faceplate viewing apertures 23 may be formed with a plurality of sizes and shapes so that when lenses 120 are removed entirely, user 1 has a relatively unimpeded view through faceplate 20 and even retainer 100 when installed.

Furthermore, lens 120 is equipped a tab or visor 124 that protrudes from lens 120 and is positioned above aperture 122. Tab 124 extends outwardly through lens access aperture 106. Tab 124 may be grasped by user 1 to rotate and position lens 120 such that aperture 122 is aligned with faceplate aperture 23 so that user 1 may accurately focus their vision through aperture 122 (of either eye or both). It should be noted that when retainer 100 secures lens 120 against faceplate 20, lens 120 is capable of being moved up, down, or side to side through a limited range of motion to adjust the position of lens aperture 122 relative to a user's eyes. In some embodiments lens aperture 122 may be moved downwardly to a point where aperture 122 is no longer in communication with retainer 100 lens access aperture 106, thereby closing lens 120 entirely for user 1. In these embodiments a user 1 may entirely block the view of one eye, for example, thereby training a single eye at a time. Additionally, in operation both lenses 120 may in some embodiments be removed entirely, thereby allowing user 1 to see through the relatively larger openings of faceplate viewing aperture 23 and retainer aperture 106. This embodiment of the invention permits a user 1 to look through a larger opening when beginning vision training, which can be very useful for catching balls or other activities where a larger field of view may be advantageous.

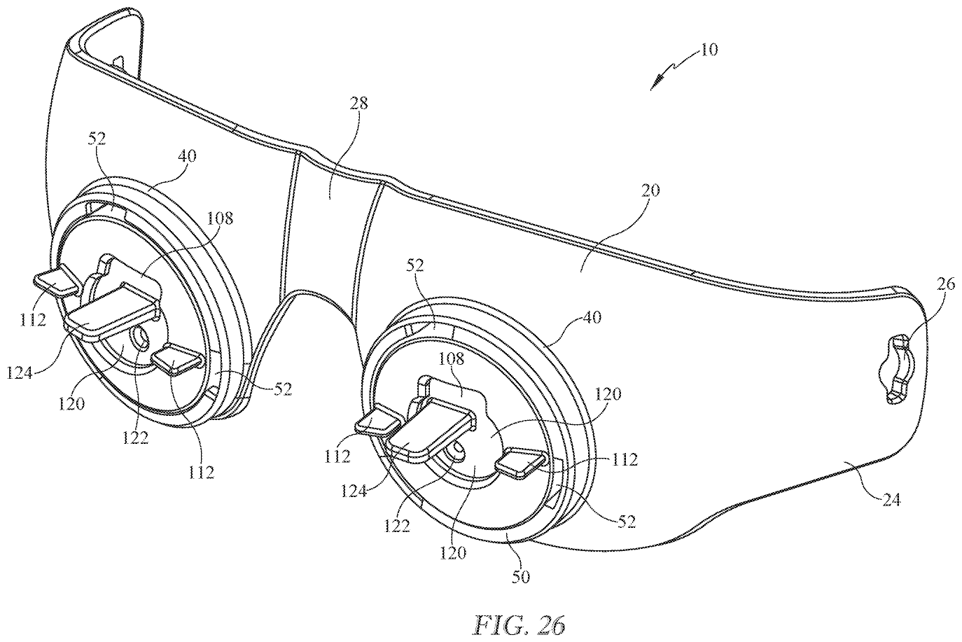

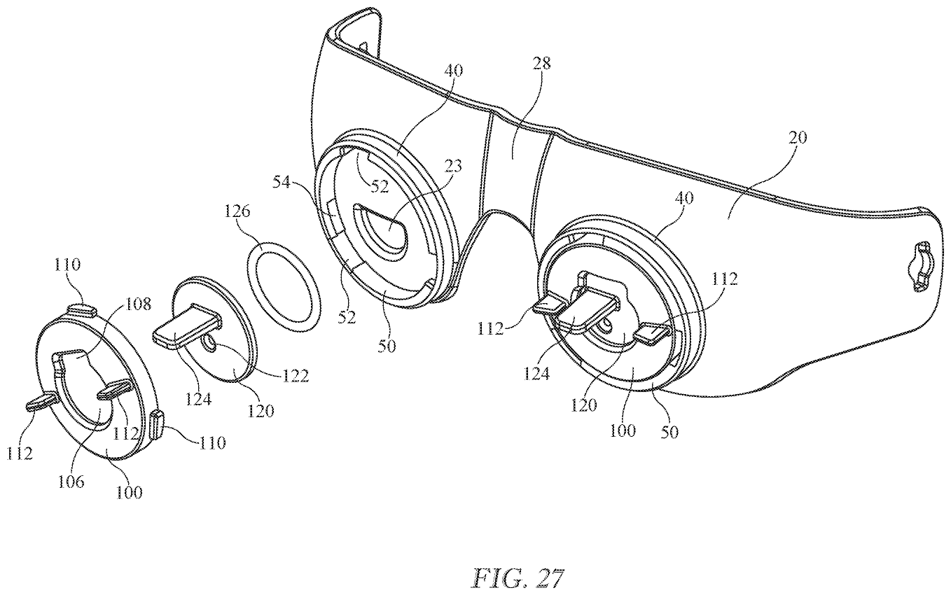

Referring now to FIGS. 26-27, and in accordance with additional embodiments, lens retainer 100 may be configured to engage faceplate 20 through operation of a twist-lock mechanism. In these embodiments ocular socket 40 may include a circumferential retainer housing 50 that includes a plurality of locking tab slots 52 recessed around the perimeter of housing 50, as well as a plurality of locking tab recesses that are in communication with locking tab slots 52. Additionally, lens retainer 100 includes a plurality of locking tabs 110 disposed around and extending from retainer 100 edge 105. Locking tabs 110 correspond with and engage locking tab slots 52 such that retainer 100 may be inserted in to ocular retainer housing 50. Once inserted, retainer 100 may then be rotated so that locking tabs slide into and engage locking tab recesses 54, thereby securing retainer 100 in ocular socket 40. In some embodiments a pair of wing tabs 112 are provided to permit user 1 to grasp and rotate retainer 100 to secure it in ocular retainer housing 50.

As depicted in FIG. 27, lens 120 may be inserted and locked into ocular socket 40, along with an o-ring 126 that may be disposed around faceplate viewing aperture 23 and positioned between lens 120 and ocular socket 40. O-ring 126 may be made of a soft compressible material, for example an elastomer material, that permits lens 120 to be easily moved by operation of tab 124 but remain in place once user 1 places lens 120 aperture 122 in a desired location. When assembled, retainer 100 forces lens 120 to compress o-ring 126 into ocular socket 40, thereby providing a secure fit for lens 120 in ocular socket while still permitting some movement of lens 120 for the purpose of positioning aperture 122 to a desired location to enable customized vision training.

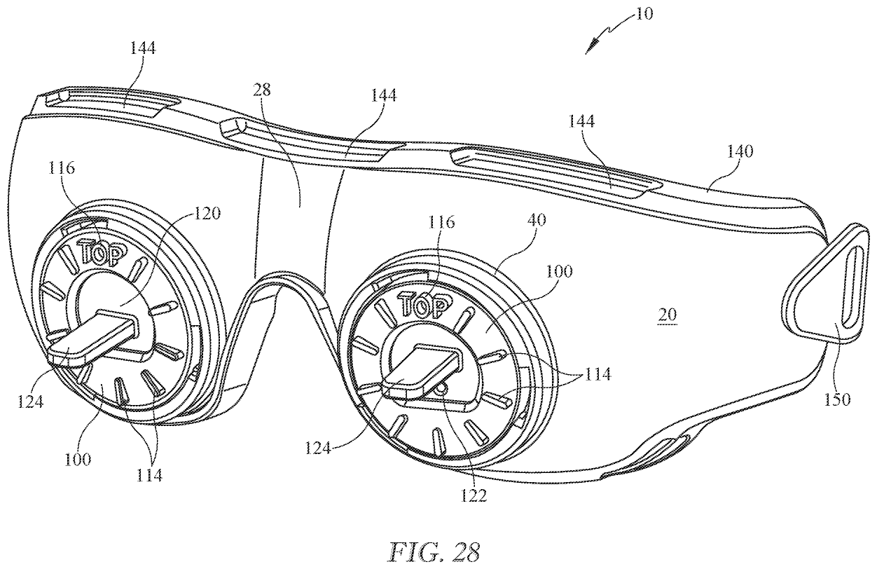

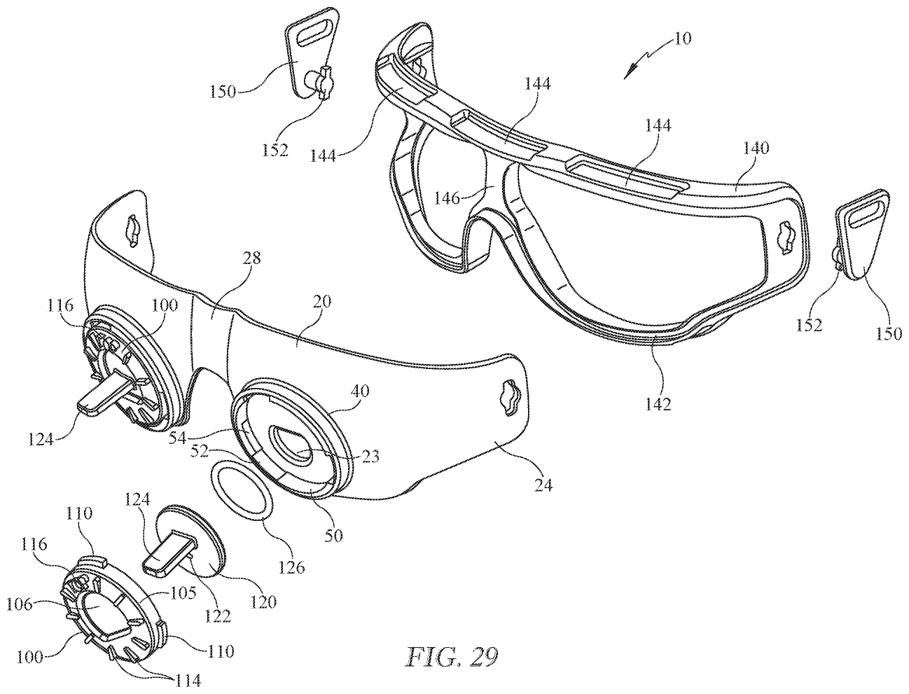

Referring now to FIGS. 28 and 29, and in accordance with some aspects and embodiments, retainer 100 may include a plurality of raised grip portions 114 disposed around edge 105 thereof in place of wing tabs 112. Raised grip portions 114 permit user 1 to easily grasp and rotate retainer 100 into engagement with retainer housing 50. Furthermore, a “TOP” raised indicia 116 may also be disposed on an upper portion of retainer 110 to facilitate the alignment of locking tabs 110 with locking tab slots 52, thereby permitting a user to quickly align and engage retainer 100 with housing 50. These features and embodiments permit user 1 to quickly and readily remove or secure retainer 100 and lens 120, thereby providing the ability to switch lenses 120 with different size lens apertures 122 for a wide variety of athletic training applications.

In accordance with some embodiments a frame 140 is provided for contacting, engaging and framing faceplate 20. Frame 140 may be formed of relatively soft elastomeric material to provide comfort for user 1. Frame 140 may be shaped to form a mating lip 142 that engages the perimeter of faceplate 20 and further include a plurality of vent holes 144 around a perimeter of frame 140 to permit heat a moisture to escape goggle 10. Frame 140 may additionally include a bridge portion 146 that covers bridge 28 of faceplate 20 where it contact a user's 1 nose. Frame 140 acts to frame faceplate 20 around its entire perimeter so that when worn, frame 140 is the only portion of goggle 10 that contacts the user's face. Frame 140 may also include a temple aperture 148 that aligns with strap aperture 26 of faceplate 20 temple 24 to facilitate securing frame 140 and faceplate 20, as described below.

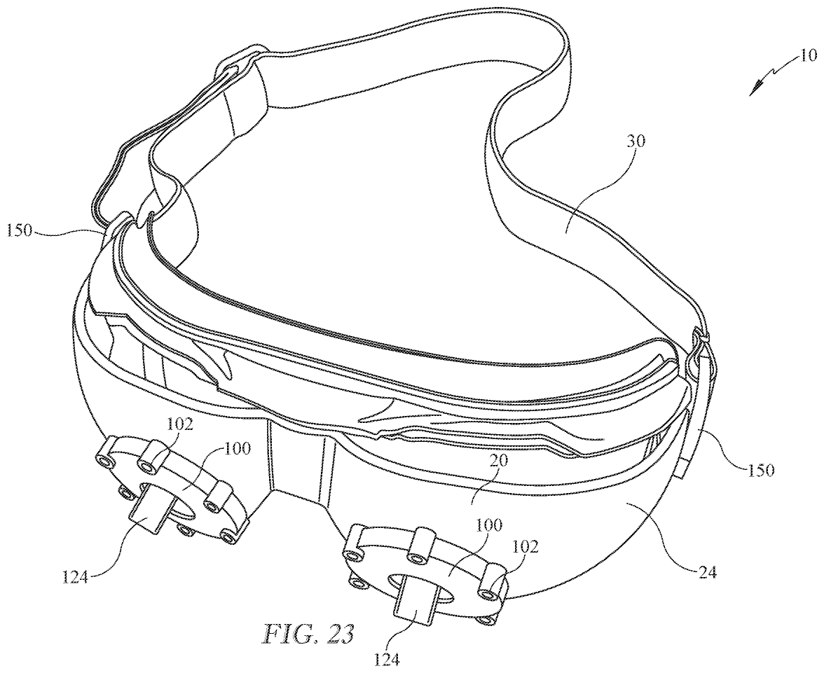

In certain embodiments as depicted in FIGS. 23, 24, 28 and 29, faceplate 20 strap aperture 26 may be shaped generally as a “t” slot 26 that is engaged by a strap lock 150. Strap lock 150 includes a shaped t-post 152 extending therefrom that is inserted through strap aperture 26 and concomitant temple aperture 148 of frame 140. Once inserted, strap lock 150 may be rotated through, for example, one-quarter turn, to lock and secure frame 140 and faceplate 20 together. Finally, a strap loop 154 may be provided integral to strap lock 150 to accept and engage strap 30. This feature of the invention provides the ability to quickly secure frame 140 and faceplate 20 together and also to quickly change goggle 10 frames 140 where desired.

While the apparatus and system for a sport training goggle 10 shown and described herein in what are considered to be the preferred embodiments thereof, illustrating the results and advantages over the prior art obtained through various embodiments, the apparatus and system is not limited to those specific embodiments. Thus, the forms of the system and apparatus shown and described herein are to be taken as illustrative only and other embodiments may be selected without departing from the scope of the claims appended hereto.

We claim:

1. A pair of sports training goggles worn on the head of a user to provide vision through an eye or eyes of said user comprising:
a faceplate having a pair of opposed temples shaped to engage the head of said user;
a pair of spaced ocular sockets disposed generally over the eyes of said user, each socket having a central aperture therein;
first and second lenses, each shaped to engage a one of said ocular sockets and occlude the central aperture thereof, said first and second lenses each having an aperture therein for directing said user's eyes in a predetermined direction.

2. The sports training goggles of claim 1 comprising:
a truncated hemispherical portion on each lens terminating in a trailing edge; and
a shaped recess disposed around the aperture of said ocular sockets, wherein said recess is engaged by said lens truncated hemispherical portion.

3. The sports training goggles of claim 2 wherein said lenses are movable within said ocular socket thereby allowing said lens apertures to be positioned to a desired focal point.

4. The sports training goggles of claim 3 wherein said lenses are movable to an open position.

5. The sports training goggles of claim 3 comprising:
a tab extending from each of said lenses, said tab located above said lens aperture, for adjusting the position of said lens within said ocular socket and shielding said aperture.

6. The sports training goggles of claim 4 wherein said shaped ocular sockets are generally hemispherical in shape.

7. The sports training goggles of claim 5 wherein the apertures of said shaped ocular sockets are directed at an angle below a horizontal orientation.

8. The sports training goggles of claim 6 wherein said lenses are removable and replaceable.

9. The sports training goggles of claim 6 wherein said first and second lenses comprise:
a variable aperture having a plurality of variable position rotatable vanes capable of inward or outward rotation to form said variable aperture.

10. The sports training goggles of claim 6 wherein said lens apertures have a predetermined minimum diameter.

11. The sports training goggles of claim 6 comprising:
a strap secured to said faceplate for securing said goggles on a user's head.

12. The sports training goggles of claim 6 wherein said faceplate is shaped to engage a user's nose, temples, and brow, and wherein said faceplate blocks light reaching a user's eyes except light entering through said lens apertures.

13. A pair of sports training goggles worn on the head of a user to provide vision through an eye or eyes of said user comprising:
a faceplate having a pair of opposed temples shaped to engage the head of said user and a pair of viewing apertures disposed in general alignment with the eyes of said user;
a pair of spaced ocular sockets disposed generally over the eyes of said user, each socket having a central aperture therein;
first and second lenses, each shaped to engage a one of said ocular sockets and occlude the central aperture thereof, said first and second lenses each having an aperture therein for directing said user's eyes in a predetermined direction.

14. The sports training goggles of claim 13 wherein said first and second lenses comprise:
a generally flat circular portion having said aperture generally in the center thereof.

15. The sports training goggles of claim 14 wherein said first and second lenses comprise:
a tab extending from said lens above said aperture for adjusting said lens aperture position.

16. The sports training goggles of claim 14 comprising:
first and second retainers for engaging said ocular sockets and capturing said lenses between said ocular sockets and said faceplate.

17. The sports training goggles of claim 16 comprising:
a plurality of locking tabs extending from a perimeter of said first and second retainers; and
a plurality of locking tab slots disposed around a perimeter of said ocular socket, wherein said locking tabs engage said locking tab slots to secure said retainers to said ocular sockets.

18. The sports training goggles of claim 16 wherein said retainers comprise:
a plurality of raised grip portions disposed around a perimeter of said retainer.

19. The sports training goggles of claim 13 comprising:
a faceplate having a temple aperture disposed in each of said temples;
a frame having a perimeter shaped to engage an outer edge of said faceplate, said frame having a pair of temple apertures that align with said faceplate temple apertures; and
a pair of strap locks, each having a post for engaging both a temple aperture of said faceplate and a temple aperture of said frame, thereby securing said frame to said faceplate.

20. The sports training goggles of claim 14 comprising:
an o-ring disposed between each of said retainers and said lenses; whereby said o-ring permits movement of said lens in said ocular socket.
